(19) United States
(12) Patent Application Publication
(10) Pub. No.: US 2024/0260612 A1
(43) Pub. Date: Aug. 8, 2024

(54) COMPOSITION FOR COLOR CHANGING BEVERAGES CONTAINING ANTHOCYANINS

(71) Applicant: AMOREPACIFIC CORPORATION, Seoul (KR)

(72) Inventors: Jeongun KIM, Yongin-si (KR); Kwanghyun SHIN, Yongin-si (KR); Juyeon SEO, Yongin-si (KR); Jinmin KIM, Yongin-si (KR); Changyong MOON, Yongin-si (KR); Wonkyung CHO, Yongin-si (KR)

(73) Assignee: AMOREPACIFIC CORPORATION, Seoul (KR)

(21) Appl. No.: 18/316,545

(22) Filed: May 12, 2023

(30) Foreign Application Priority Data
Feb. 7, 2023 (KR) 10-2023-0015869

(51) Int. Cl. A23L 2/58; A23L 2/39; A23L 2/68

(52) U.S. Cl. CPC A23L 2/58; A23L 2/39; A23L 2/68

(57) ABSTRACT

The present invention relates to a composition for a color changing beverage containing anthocyanins. More specifically, the present invention relates to a composition for a beverage having a color change so that the antioxidant effect of an anthocyanin-containing extract can be visually recognized.

### CROSS-REFERENCE TO RELATED APPLICATION

This application claims priority to and the benefit of Korean Patent Application No. 10-2023-0015869 filed on Feb. 7, 2023, the entire contents of which are hereby incorporated by reference.

### BACKGROUND

### 1. Field of the Invention

The present invention relates to a composition for a color changing beverage containing anthocyanins. More specifically, the present invention relates to a composition for a beverage having a color change so that the antioxidant effect of an anthocyanin-containing extract can be visually recognized.

### 2. Discussion of Related Art

Recently, as the interest in health is focused, various studies are being conducted to prevent aging, disease and the like caused by active oxygens. The active oxygens are substances that cause various diseases or accelerate aging by oxidizing cells and tissues in the human body, and it is necessary to remove these active oxygens or suppress the activity of the active oxygens. In this regard, technical studies on an antioxidant beverage composition to prevent aging, disease, and the like by the active oxygens using plant extracts are being actively conducted.

A representative plant extract having an antioxidant effect is anthocyanin extracts. The anthocyanin extracts have colors such as red, reddish purple, and purple, and are relatively stable in low temperature or dry conditions, but are weak to heat and are discolored by metal ions or pH. Depending on the pH, they are red in acidity, indigo in neutral, and blue in alkali, and are discolored by salts, sugars, amino acids, vitamin C, and enzymes.

Anthocyanins are flavonoid-based substances that have little odor and taste. In particular, the anthocyanins act as antioxidants that eliminate active oxygens (reactive oxygen species) produced in plant cells.

Conventional beverage compositions containing anthocyanin extracts have a problem in that they have dark colors such as reddish purple and blue-green and do not have a good taste or aroma, making them unwilling to consume them as beverages.

Therefore, there is a need for a study on a beverage composition that has an excellent antioxidant effect and can express high preference in terms of color, taste, and aroma.

### PRIOR ART DOCUMENT

### Patent Document

(Patent Document 1) US Patent Publication No. 2016-0165940 (2016 Jun. 16)

### SUMMARY OF THE INVENTION

In order to solve the above problems, the inventors of the present invention have studied a composition for a beverage excellent in esthetics and preference as well as antioxidant effect by containing a substance including acidic or basic particles coated with a water-soluble polymer, in addition to an anthocyanin-containing extract, and thus have completed the present invention.

Therefore, it is an object of the present invention to provide a composition for a beverage capable of visually recognizing the antioxidant effect of an anthocyanin-containing extract through a color change according to a dissolution time difference.

According to the first aspect of the present invention, the present invention provides a composition for a beverage comprising a first substance comprising an anthocyanin-containing extract; and a second substance comprising acidic particles and a coating layer containing a water-soluble polymer.

In addition, the present invention provides a composition for a beverage, wherein the pH of a solution in which the first substance is dissolved is 5 or more.

In addition, the present invention provides a composition for a beverage, wherein the dissolution of the acidic particles has a time difference of 1 second or more after the start of dissolution of the first substance.

In addition, the present invention provides a composition for a beverage, wherein the acidic particle is at least one selected from citric acid, malic acid, tartaric acid, gluconic acid, lactic acid, vitamin C, gluconolactone, L-aspartame, L-glutamic acid, acidic sodium pyrophosphate, potassium hydrogen tartrate, sodium phosphate monobasic, potassium phosphate monobasic and citrus-containing extract powder.

In addition, the present invention provides a composition for a beverage, wherein the size of the acidic particles is 100 μm to 5,000 μm.

In addition, the present invention provides a composition for a beverage, wherein the water-soluble polymer is at least one selected from hydroxypropyl methyl cellulose, methyl cellulose, hydroxypropyl cellulose, guar gum, gum arabic, locust bean gum, gellan gum, xanthan gum, carrageenan, gum tragacanth, gum karaya, gum ghatti, dhamma gum, psyllium seed gum, tamarind gum, tara gum, polyvinylpyrrolidone and modified starch.

In addition, the present invention provides a composition for a beverage, wherein the first substance further comprises a basic substance.

In addition, the present invention provides a composition for a beverage, wherein the basic substance is at least one selected from trisodium citrate, potassium citrate, sodium hydroxide, potassium hydroxide, calcium hydroxide, sodium carbonate, magnesium carbonate, sodium hydrogen carbonate, potassium hydrogen carbonate, potassium carbonate, calcium carbonate, sodium pyrophosphate, potassium pyrophosphate, sodium phosphate dibasic, sodium phosphate tribasic, potassium phosphate dibasic, potassium phosphate tribasic, arginine, histidine, lysine, sodium tartrate and sodium malate.

According to the second aspect of the present invention, the present invention provides a composition for a beverage comprising a third substance comprising an anthocyanin containing extract; and a fourth substance comprising basic particles and a coating layer containing a water-soluble polymer.

In addition, the present invention provides a composition for a beverage, wherein the pH of the solution in which the third substance is dissolved is less than 5.

In addition, the present invention provides a composition for a beverage, wherein the dissolution of the basic particles has a time difference of 1 second or more after the start of dissolution of the third substance.

In addition, the present invention provides a composition for a beverage, wherein the basic particle is at least one selected from trisodium citrate, tripotassium citrate, sodium tartrate, sodium malate, sodium carbonate, magnesium carbonate, sodium hydrogen carbonate, potassium hydrogen carbonate, potassium carbonate, sodium pyrophosphate, potassium pyrophosphate, sodium phosphate dibasic, sodium phosphate tribasic, potassium phosphate dibasic and potassium phosphate tribasic.

In addition, the present invention provides a composition for a beverage, wherein the size of the basic particles is 100 μm to 5,000 μm.

In addition, the present invention provides a composition for a beverage, wherein the water-soluble polymer is at least one selected from hydroxypropyl methyl cellulose, methyl cellulose, hydroxypropyl cellulose, guar gum, gum arabic, locust bean gum, gellan gum, xanthan gum, carrageenan, gum tragacanth, gum karaya, gum ghatti, dhamma gum, psyllium seed gum, tamarind gum, tara gum, polyvinylpyrrolidone and modified starch.

In addition, the present invention provides a composition for a beverage, wherein the third substance further comprises an acidic substance.

In addition, the present invention provides a composition for a beverage, wherein the acidic substance is at least one selected from citric acid, malic acid, tartaric acid, gluconic acid, lactic acid, vitamin C, gluconolactone, L-aspartame, L-glutamic acid, acidic sodium pyrophosphate, potassium hydrogen tartrate, sodium phosphate monobasic, potassium phosphate monobasic and citrus-containing extract powder.

In addition, the present invention provides a composition for a beverage, wherein the composition is in the form of a powder.

The composition for a beverage according to the present invention has very excellent esthetics and preference as well as antioxidant effect by containing the anthocyanin extract, so it can be drunk without aversion.

In addition, in the composition for a beverage according to the present invention, the antioxidant effect of the anthocyanin-containing extract can be visually recognized through color change according to the dissolution time difference.

### DESCRIPTION OF DRAWINGS

FIGS. 1 to 8 are photographs showing the degree of dissolution according to the time difference of the composition for a beverage according to an embodiment.

FIG. 9 is a photograph showing the degree of dissolution according to the time difference of the composition for a beverage according to Comparative Example.

### DETAILED DESCRIPTION OF EXEMPLARY EMBODIMENTS

The embodiments provided according to the present invention can all be achieved by the following description. It should be understood that the following description describes preferred embodiments of the present invention and it should be understood that the present invention is not necessarily limited thereto.

The inventors of the present invention have recognized that the compositions for a beverage containing anthocyanin extracts according to the prior art have a problem in that they have dark colors such as reddish purple and blue-green and do not have a good taste or aroma, and thus the user is reluctant to consume them as beverages.

In order to solve the above problems, the inventors of the present invention have found that by forming acidic or basic particles including a coating layer in the composition for a beverage, when the composition for a beverage is dissolved in water, color change occurs with a dissolution time difference, and thus the user can visually recognize the antioxidant effect and a composition having a refreshing taste can also be prepared, and thus have completed the present invention.

In one embodiment of the present invention, the composition for a beverage comprises a first substance comprising an anthocyanin containing extract; and a second substance comprising acidic particles and a coating layer containing a water-soluble polymer.

In one embodiment of the present invention, the first substance comprising an anthocyanin containing extract means a substance containing a large amount of anthocyanin components, which can be obtained by extracting and pulverizing anthocyanin components from the following plants in the same ratio or according to a process selected at the discretion of a person skilled in the art:
hibiscus, red cabbage, red radish, grape skin, purple sweet potato, blue mellow (mallow flower), butterfly fee, black rice, eggplant, blueberry, black carrot, Chinese matrimony vine, aronia, elderberry, mulberry, bilberry, acai berry, blackcurrant, raspberry, black plum, black bean, beet, grape, Korean wild grape and wild vine.

In one embodiment of the present invention, the acidic particles refer to particles that are acidic when dissolved in water. In one embodiment, the acidic particles may be at least one selected from organic acids such as citric acid, malic acid, tartaric acid, gluconic acid, lactic acid, vitamin C, and gluconolactone; acidic amino acids such as L-aspartame and L-glutamic acid; acid salts such as acidic sodium pyrophosphate, potassium hydrogen tartrate, sodium phosphate monobasic, and potassium phosphate monobasic; and citrus-containing extract powder.

The acidic particles may have a size of 100 μm to 5,000 μm. In one embodiment, the acidic particles may have a size of 100 μm or more, 150 μm or more, 200 μm or more, 250 μm or more, 300 μm or more, 350 μm or more, 400 μm or more, 450 μm or more, 500 μm or more, 550 μm or more, 600 μm or more, 650 μm or more, 700 μm or more, 750 μm or more, 800 μm or more, 850 μm or more, 900 μm or more, 950 μm or more or 1,000 μm or more. In one embodiment, the acidic particles may have a size of 5,000 μm or less, 4,900 μm or less, 4,800 μm or less, 4,700 μm or less, 4,600 μm or less, 4,500 μm or less, 4,400 μm or less, 4,300 μm or less, 4,200 μm or less, 4,100 μm or less, 4,000 μm or less, 3,900 μm or less, 3,800 μm or less, 3,700 μm or less, 3,600 μm or less, 3,500 μm or less, 3,400 μm or less, 3,300 μm or less, 3,200 μm or less, 3,100 μm or less or 3,000 μm or less. In addition, combinations of the above ranges (for example, 100 μm or more and 4,500 μm or less, 200 μm or more and 4,000 μm or less and the like) are possible, but other ranges are also possible.

If the size of the acidic particles is less than 100 μm, the size is too small to form a coating layer containing a water-soluble polymer. If the size of the acidic particles exceeds 5,000 μm, since the dissolution rate of the acidic particles is slow after the initiation of dissolution and thus the user has to wait until the particles are completely dissolved, there is a problem that the convenience of drinking beverage is lowered.

In one embodiment of the present invention, the water-soluble polymer is a substance that coats acidic particles and is a water-soluble polymer. In one embodiment, the water-soluble polymer may be at least one selected from cellulose series such as hydroxypropyl methyl cellulose, methyl cellulose, and hydroxypropyl cellulose; gums such as guar gum, gum arabic, locust bean gum, gellan gum, xanthan gum, carrageenan, gum tragacanth, gum karaya, gum ghatti, dhamma gum, psyllium seed gum, tamarind gum, and tara gum; polyvinylpyrrolidone and modified starch.

In one embodiment of the present invention, the content of the coating layer including the water-soluble polymer may be 0.5% by weight to 10% by weight based on the total weight of the sum of acidic particles and the water-soluble polymer. In one embodiment, the content of the coating layer including the water-soluble polymer may be 0.5% by weight or more, 1.0% by weight or more, 1.5% by weight or more, 2.0% by weight or more, 2.5% by weight or more, 3.0% by weight or more, 3.5% by weight or more, 4.0% by weight or more, 4.5% by weight or more or 5.0% by weight or more based on the total weight of the sum of the acidic particles and the water-soluble polymer. In one embodiment, the content of the coating layer including the water-soluble polymer may be 10% by weight or less, 9.5% by weight or less, 9.0% by weight or less, 8.5% by weight or less, 8.0% by weight or less, 7.5% by weight or less, 7.0% by weight or less, 6.5% by weight or less or 6.0% by weight or less based on the total weight of the sum of the acidic particles and the water-soluble polymer. In addition, combinations of the above ranges (for example, 1% by weight or more and 8% by weight or less, 0.5% by weight or more and 5% by weight or less and the like) are possible, but other ranges are also possible.

If the content of the coating layer including the water-soluble polymer is less than 0.5% by weight based on the total weight of the sum of the acidic particles and the water-soluble polymer, the coating effect by the water-soluble polymer of the acidic particles is insignificant. If the content of the coating layer including the water-soluble polymer exceeds 10% by weight, there is a problem that the color change of the composition for a beverage does not occur quickly because the content of the coating layer is high compared to the acidic particles, so that the dissolution of the water-soluble polymer is delayed.

In one embodiment of the present invention, the pH of the solution in which the first substance comprising an anthocyanin containing extract is dissolved may be 5 or more. The reason for including the substance having a pH of 5 or higher after being dissolved as described above is to visually recognize the color change according to the change in pH, when the acidic particles coated with the water-soluble polymer in the composition for a beverage are dissolved with a dissolution time difference.

In one embodiment of the present invention, the first substance may further comprise a basic substance. If the pH of the solution in which the first substance comprising an anthocyanin containing extract is dissolved is less than 5, the solution may further comprise the basic substance. The reason is to visually recognize the color change according to the pH change when the acidic particles are dissolved, by providing an environment in which the solution in which the first substance is dissolved has a pH of 5 or higher, before the acidic particles coated with the water-soluble polymer in the composition for a beverage are dissolved with a dissolution time difference.

In one embodiment, the basic substance may be at least one selected from basic substances comprising a citric group such as trisodium citrate and potassium citrate; basic substances comprising a hydroxyl group such as sodium hydroxide, potassium hydroxide and calcium hydroxide; basic substances comprising a carbonic acid group such as sodium carbonate, magnesium carbonate, sodium hydrogen carbonate, potassium hydrogen carbonate, potassium carbonate and calcium carbonate; basic substances comprising a phosphate group such as sodium pyrophosphate, potassium pyrophosphate, sodium phosphate dibasic, sodium phosphate tribasic, potassium phosphate dibasic and potassium phosphate tribasic; basic amino acids such as arginine, histidine and lysine; sodium tartrate and sodium malate.

In one embodiment of the present invention, the dissolution of the acidic particles may have a time difference of 1 second or more after the start of dissolution of the first substance. Accordingly, when the composition for a beverage in which the first substance and the second substance are mixed is dissolved in a solvent (for example, water), since the first substance is first dissolved and at the same time, in the case of the second substance, the coating layer containing the acidic particles is first dissolved, the acidic particles begin to dissolve after the coating layer is dissolved. Accordingly, the dissolution of the acidic particles may have a time difference of 1 second or more after the start of dissolution of the first substance, and at this time, a color change may occur as the pH is changed.

In one embodiment of the present invention, the composition for a beverage comprises a third substance comprising an anthocyanin containing extract; and a fourth substance comprising basic particles and a coating layer containing a water-soluble polymer.

In one embodiment of the present invention, the third substance comprising the anthocyanin containing extract means a substance containing a large amount of anthocyanin components, which can be obtained by extracting and pulverizing anthocyanin components from the following plants in the same ratio or according to a process selected at the discretion of a person skilled in the art:
hibiscus, red cabbage, purple sweet potato, blue mellow (mallow flower), butterfly fee, black rice, eggplant, blueberry, black carrot, Chinese matrimony vine, aronia, elderberry, mulberry, bilberry, acai berry, blackcurrant, raspberry, black plum, black bean, beet, grape, Korean wild grape and wild vine.

In one embodiment of the present invention, the basic particles refer to particles that are basic when dissolved in water. In one embodiment, the basic particles may be at least one selected from basic substances comprising a citric group such as trisodium citrate and potassium citrate; basic substances comprising a hydroxyl group such as sodium hydroxide, potassium hydroxide and calcium hydroxide; basic substances comprising a carbonic acid group such as sodium carbonate, magnesium carbonate, sodium hydrogen carbonate, potassium hydrogen carbonate, potassium carbonate and calcium carbonate; basic substances comprising a phosphate group such as sodium pyrophosphate, potassium pyrophosphate, sodium phosphate dibasic, sodium phosphate tribasic, potassium phosphate dibasic and potassium phosphate tribasic; basic amino acids such as arginine, histidine and lysine; sodium tartrate and sodium malate.

The size of the basic particles may be 100 μm to 5,000 μm. In one embodiment, the size of the basic particles may be 100 μm or more, 150 μm or more, 200 μm or more, 250 μm or more, 300 μm or more, 350 μm or more, 400 μm or more, 450 μm or more, 500 μm or more, 550 μm or more, 600 μm or more, 650 μm or more, 700 μm or more, 750 μm or more, 800 μm or more, 850 μm or more, 900 μm or more, 950 μm or more or 1,000 μm or more. In one embodiment, the size of the basic particles may be 5,000 μm or less, 4,900 μm or less, 4,800 μm or less, 4,700 μm or less, 4,600 μm or less, 4,500 μm or less, 4,400 μm or less, 4,300 μm or less, 4,200 μm or less, 4,100 μm or less, 4,000 μm or less, 3,900 μm or less, 3,800 μm or less, 3,700 μm or less, 3,600 μm or less, 3,500 μm or less, 3,400 μm or less, 3,300 μm or less, 3,200 μm or less, 3,100 μm or less or 3,000 μm or less. In addition, combinations of the above ranges (for example, 100 μm or more and 4,500 μm or less, 200 μm or more and 4,000 μm or less and the like) are possible, but other ranges are also possible.

If the size of the basic particles is less than 100 μm, since the size is too small, it is difficult to form a coating layer containing a water-soluble polymer. If the size of the basic particles exceeds 5,000 μm, since the dissolution rate of the basic particles is slow after the initiation of dissolution and thus the user has to wait until the particles are completely dissolved, there is a problem that the convenience of drinking beverage is lowered.

In one embodiment of the present invention, the water-soluble polymer is a substance that coats the basic particles and is a water-soluble polymer. In one embodiment, the water-soluble polymer may be at least one selected from cellulose series such as hydroxypropyl methyl cellulose, methyl cellulose, and hydroxypropyl cellulose; gums such as guar gum, gum arabic, locust bean gum, gellan gum, xanthan gum, carrageenan, gum tragacanth, gum karaya, gum ghatti, dhamma gum, psyllium seed gum, tamarind gum, and tara gum; polyvinylpyrrolidone and modified starch.

In one embodiment of the present invention, the content of the coating layer including the water-soluble polymer may be 0.5% by weight to 10% by weight based on the total weight of the sum of the basic particles and the water-soluble polymer. In one embodiment, the content of the coating layer including the water-soluble polymer may be 0.5% by weight or more, 1.0% by weight or more, 1.5% by weight or more, 2.0% by weight or more, 2.5% by weight or more, 3.0% by weight or more, 3.5% by weight or more, 4.0% by weight or more, 4.5% by weight or more or 5.0% by weight or more based on the total weight of the sum of the basic particles and the water-soluble polymer. In one embodiment, the content of the coating layer including the water-soluble polymer may be 10% by weight or less, 9.5% by weight or less, 9.0% by weight or less, 8.5% by weight or less, 8.0% by weight or less, 7.5% by weight or less, 7.0% by weight or less, 6.5% by weight or less or 6.0% by weight or less based on the total weight of the sum of the basic particles and the water-soluble polymer. In addition, combinations of the above ranges (for example, 1% by weight or more and 8% by weight or less, 0.5% by weight or more and 5% by weight or less and the like) are possible, but other ranges are also possible.

If the content of the coating layer including the water-soluble polymer is less than 0.5% by weight based on the total weight of the sum of the basic particles and the water-soluble polymer, the coating effect by the water-soluble polymer of the basic particles is insignificant. If the content of the coating layer including the water-soluble polymer exceeds 10% by weight, there is a problem that the color change of the composition for a beverage does not occur quickly because the content of the coating layer is high compared to the acidic particles, so that the dissolution of the water-soluble polymer is delayed.

In one embodiment of the present invention, the pH of the solution in which the third substance containing an anthocyanin containing extract is dissolved may be less than 5. The reason for including the substance having a pH of less than 5 after being dissolved as described above is to visually recognize the color change according to the change in pH, when the basic particles coated with the water-soluble polymer in the composition for a beverage are dissolved with a dissolution time difference.

In one embodiment of the present invention, the third substance may further comprise an acidic substance. If the pH of the solution in which the third substance comprising an anthocyanin containing extract is dissolved is 5 or more, the solution may further comprise the acidic substance. The reason is to visually recognize the color change according to the pH change when the basic particles are dissolved, by providing an environment in which the solution in which the third substance is dissolved has a pH of less than 5, before the basic particles coated with the water-soluble polymer in the composition for a beverage are dissolved with a dissolution time difference.

In one embodiment, the acidic substance may be at least one selected from organic acids such as citric acid, malic acid, tartaric acid, gluconic acid, lactic acid, vitamin C, and gluconolactone; acidic amino acids such as L-aspartame and L-glutamic acid; acid salts such as acidic sodium pyrophosphate, potassium hydrogen tartrate, sodium phosphate monobasic, and potassium phosphate monobasic; and citrus-containing extract powder.

In one embodiment of the present invention, the dissolution of the basic particles may have a time difference of 1 second or more after the start of dissolution of the third substance. Accordingly, when the composition for a beverage in which the third substance and the fourth substance are mixed is dissolved in a solvent (for example, water), since the third substance is first dissolved and at the same time, in the case of the fourth substance, the coating layer containing the basic particles is first dissolved, the basic particles begin to dissolve after the coating layer is dissolved. Accordingly, the dissolution of the basic particles may have a time difference of 1 second or more after the start of dissolution of the third substance, and at this time, a color change may occur as the pH is changed.

In one embodiment of the present invention, the composition may be in the form of a powder.

Hereinafter, preferred examples are presented to help understand the present invention. However, the following examples are merely illustrative of the present invention, and it is obvious to those skilled in the art that various changes and modifications are possible within the scope and spirit of the present invention, and it is natural that these changes and modifications fall within the scope of the appended claims.

### Preparation of Composition for Beverage

### Example 1

A powdered anthocyanin containing extract was prepared from a red cabbage extract.

A coating solution in which hydroxypropyl methyl cellulose was dissolved was added to citric acid particles having a particle size of 2000 μm, which is 10 mesh, to prepare a powder containing acid particles coated with a water-soluble polymer containing 1% by weight of hydroxypropyl methyl cellulose by total weight of the citric acid and the hydroxypropyl methyl cellulose on the surface of the citric acid particles.

A composition for a beverage was prepared by mixing the powder containing the anthocyanin-containing extract and the powder containing the acidic particles coated with a water-soluble polymer at a ratio of 1:2.

### Example 2

A powdered anthocyanin containing extract was prepared from a hibiscus extract.

A coating solution in which gum arabic was dissolved was added to gluconolactone particles having a particle size of 500 μm, which is 35 mesh, to prepare a powder containing acid particles coated with a water-soluble polymer containing 2% by weight of gum arabic by total weight of the gluconolactone particles and the gum arabic on the surface of the gluconolactone particles.

A composition for a beverage was prepared by further mixing potassium phosphate dibasic to the powder comprising the anthocyanin-containing extract and the powder comprising the acidic particles coated with a water-soluble polymer.

### Example 3

A coating solution in which hydroxypropyl cellulose was dissolved was added to citric acid particles having a particle size of 1000 μm, which is 18 mesh, to prepare a powder containing acid particles coated with a water-soluble polymer containing 0.5% by weight of hydroxypropyl cellulose by total weight of the citric acid and the hydroxypropyl cellulose on the surface of the citric acid particles.

A composition for a beverage was prepared by further mixing arginine to a powder comprising a hibiscus extract as an anthocyanin-containing extract and the powder comprising the acidic particles coated with the water-soluble polymer.

### Example 4

A coating solution in which guar gum was dissolved was added to malic acid particles having a particle size of 100 μm, which is 140 mesh, to prepare a powder containing acid particles coated with a water-soluble polymer containing 1% by weight of guar gum by total weight of the malic acid and the guar gum on the surface of the malic acid particles.

A composition for a beverage was prepared by further mixing sodium hydrogen carbonate to a powder comprising a red radish extract as an anthocyanin-containing extract and the powder comprising the acidic particles coated with the water-soluble polymer.

### Example 5

A coating solution in which hydroxypropyl methyl cellulose was dissolved was added to tartaric acid particles having a particle size of 1000 μm, which is 18 mesh, to prepare a powder containing acid particles coated with a water-soluble polymer containing 5% by weight of hydroxypropyl methyl cellulose by total weight of the tartaric acid and the hydroxypropyl methyl cellulose on the surface of the tartaric acid particles.

A composition for a beverage was prepared by further mixing trisodium citrate to a powder comprising a grape skin extract as an anthocyanin-containing extract and the powder comprising the acidic particles coated with the water-soluble polymer.

### Example 6

A coating solution in which carrageenan was dissolved was added to citric acid particles having a particle size of 500 μm, which is 35 mesh, to prepare a powder containing acid particles coated with a water-soluble polymer containing 1% by weight of carrageenan by total weight of the citric acid and the carrageenan on the surface of the citric acid particles.

A composition for a beverage was prepared by mixing a powder comprising a purple sweet potato extract as an anthocyanin-containing extract and the powder comprising the acidic particles coated with the water-soluble polymer.

### Example 7

A coating solution in which hydroxypropyl methyl cellulose was dissolved was added to citric acid particles having a particle size of 4000 μm, which is 5 mesh, to prepare a powder containing acid particles coated with a water-soluble polymer containing 10% by weight of hydroxypropyl methyl cellulose by total weight of the citric acid and the hydroxypropyl methyl cellulose on the surface of the citric acid particles.

A composition for a beverage was prepared by mixing a powder comprising a red cabbage extract as an anthocyanin-containing extract and the powder comprising the acidic particles coated with the water-soluble polymer.

### Example 8

A coating solution in which hydroxypropyl cellulose was dissolved was added to arginine particles having a particle size of 100 μm, which is 140 mesh, to prepare a powder containing basic particles coated with a water-soluble polymer containing 1% by weight of hydroxypropyl cellulose by total weight of the arginine and the hydroxypropyl cellulose on the surface of the arginine particles.

A composition for a beverage was prepared by mixing a powder comprising a grape skin extract as an anthocyanin-containing extract and the powder comprising the basic particles coated with the water-soluble polymer.

### Comparative Example 1

A composition for a beverage was prepared by mixing a powder comprising a red cabbage extract as an anthocyanin containing extract and a powder comprising citric acid particles having a particle size of 2,000 μm and a 10 mesh.

### Experimental Example

The compositions for a beverage prepared in Examples 1 to 8 and Comparative Example 1 were dissolved in water (300 ml), and the dissolution time, color, and pH of the solution were observed.

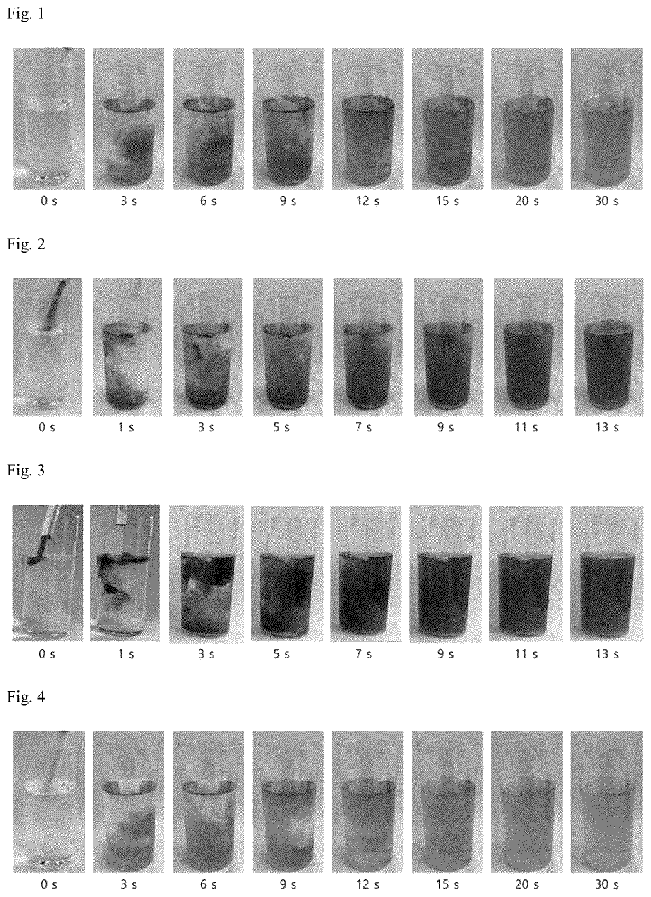

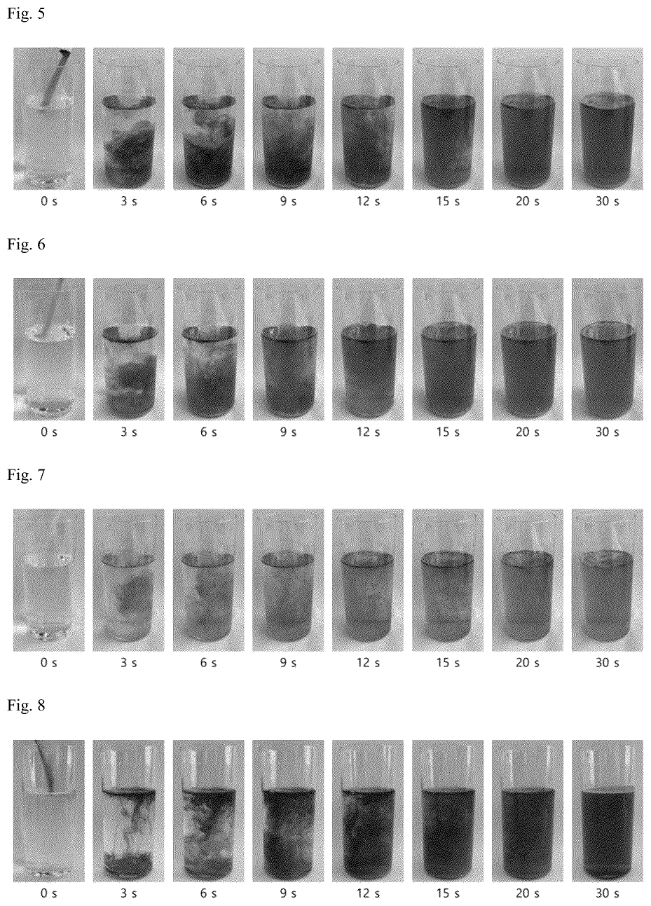

FIGS. 1 to 8 are photographs showing the degree of dissolution according to the time difference of the compositions for a beverage according to Examples 1 to 8.

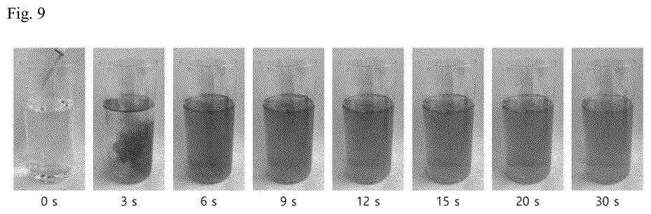

FIG. 9 is a photograph showing the degree of dissolution according to the time difference of the composition for a beverage according to the Comparative Example.

In the case of the composition for a beverage according to Example 1 above, the red cabbage extract was dissolved first for 6 seconds after dissolving in water, giving it a purple color, and the pH of the solution was 5.5.

The color of the solution gradually turned pink from 9 seconds after the composition began to dissolve in water, and at this time, the pH of the solution was 4.0. Accordingly, after the hydroxypropyl cellulose is dissolved, the acidic citric acid particles were dissolved, and the acidic particles coated with the water-soluble polymer were dissolved with a time difference, and thus the composition for a beverage having a color change could be visually confirmed.

In addition, in the case of the composition for a beverage according to Example 2, the hibiscus extract was dissolved first for 7 seconds after dissolving in water, giving it a dark reddish-purple color, and the pH of the solution was 6.5. The color of the solution gradually turned red from 9 seconds after the composition began to dissolve in water, and at this time, the pH of the solution was 3.7.

In addition, in the case of the composition for a beverage according to Example 3, the hibiscus extract and arginine were dissolved first for 5 seconds after dissolving in water, giving it a dark reddish-purple color, and the pH of the solution was 6.4. The color of the solution gradually turned red from 7 seconds after the composition began to dissolve in water, and at this time, the pH of the solution was 3.4.

In addition, in the case of the composition for a beverage according to Example 4, the red radish extract and sodium hydrogen carbonate were dissolved first for 9 seconds after dissolving in water, giving it a light purple color, and the pH of the solution was 7.0. The color of the solution gradually turned pink from 12 seconds after the composition began to dissolve in water, and at this time, the pH of the solution was 4.2.

In addition, in the case of the composition for a beverage according to Example 5, the grape skin extract and trisodium citrate were dissolved first for 6 seconds after dissolving in water, giving it an indigo blue-purple color, and the pH of the solution was 6.5. The color of the solution gradually turned scarlet from 9 seconds after the composition began to dissolve in water, and at this time, the pH of the solution was 3.6.

In addition, in the case of the composition for a beverage according to Example 6, the purple sweet potato extract was dissolved first for 6 seconds after dissolving in water, giving it a purple color, and the pH of the solution was 5.6. The color of the solution gradually turned pink from 9 seconds after the composition began to dissolve in water, and at this time, the pH of the solution was 3.5.

In addition, in the case of the composition for a beverage according to Example 7, the red cabbage extract was dissolved first for 12 seconds after dissolving in water, giving it a purple color, and the pH of the solution was 5.4. The color of the solution gradually turned pink from 15 seconds after the composition began to dissolve in water, and at this time, the pH of the solution was 3.8.

In addition, in the case of the composition for a beverage according to Example 8, the grape skin extract was dissolved first for 6 seconds after dissolving in water, giving it a red color, and the pH of the solution was 3.9. The color of the solution gradually turned dark purple from 9 seconds after the composition began to dissolve in water, and at this time, the pH of the solution was 6.8.

In the case of the composition for a beverage according to Comparative Example 1, the red cabbage extract was dissolved for 3 seconds after dissolving in water, giving it a slightly purple color, but after that, as citric acid was dissolved together, the color of the solution turned pink immediately. Unlike Examples 1 to 8, as soon as the red cabbage extract was dissolved, it turned pink, and it was confirmed that it is not a composition for a beverage in which a color change can be observed.

1. A composition for a beverage, comprising a first substance comprising an anthocyanin-containing extract; and a second substance comprising acidic particles and a coating layer containing a water-soluble polymer.

2. The composition for a beverage according to claim 1, wherein pH of a solution in which the first substance is dissolved is 5 or more.

3. The composition for a beverage according to claim 1, wherein dissolution of the acidic particles has a time difference of 1 second or more after start of dissolution of the first substance.

4. The composition for a beverage according to claim 1, wherein acidic particles are selected from the group consisting of citric acid, malic acid, tartaric acid, gluconic acid, lactic acid, vitamin C, gluconolactone, L-aspartame, L-glutamic acid, acidic sodium pyrophosphate, potassium hydrogen tartrate, sodium phosphate monobasic, potassium phosphate monobasic, citrus-containing extract powder, and a combination thereof.

5. The composition for a beverage according to claim 1, wherein size of the acidic particles is 100 μm to 5,000 μm.

6. The composition for a beverage according to claim 1, wherein the water-soluble polymer is selected from the group consisting of hydroxypropyl methyl cellulose, methyl cellulose, hydroxypropyl cellulose, guar gum, gum arabic, locust bean gum, gellan gum, xanthan gum, carrageenan, gum tragacanth, gum karaya, gum ghatti, dhamma gum, psyllium seed gum, tamarind gum, tara gum, polyvinylpyrrolidone, modified starch, and a combination thereof.

7. The composition for a beverage according to claim 1, wherein the first substance further comprises a basic substance.

8. The composition for a beverage according to claim 7, wherein the basic substance is selected from the group consisting of trisodium citrate, potassium citrate, sodium hydroxide, potassium hydroxide, calcium hydroxide, sodium carbonate, magnesium carbonate, sodium hydrogen carbonate, potassium hydrogen carbonate, potassium carbonate, calcium carbonate, sodium pyrophosphate, potassium pyrophosphate, sodium phosphate dibasic, sodium phosphate tribasic, potassium phosphate dibasic, potassium phosphate tribasic, arginine, histidine, lysine, sodium tartrate, sodium malate, and a combination thereof.

9. A composition for a beverage, comprising a third substance comprising an anthocyanin-containing extract; and a fourth substance comprising basic particles and a coating layer containing a water-soluble polymer.

10. The composition for a beverage according to claim 9, wherein pH of a solution in which the third substance is dissolved is less than 5.

11. The composition for a beverage according to claim 9, wherein dissolution of the basic particles has a time difference of 1 second or more after start of dissolution of the third substance.

12. The composition for a beverage according to claim 9, wherein the basic particles are selected from trisodium citrate, tripotassium citrate, sodium tartrate, sodium malate, sodium carbonate, magnesium carbonate, sodium hydrogen carbonate, potassium hydrogen carbonate, potassium carbonate, sodium pyrophosphate, potassium pyrophosphate, sodium phosphate dibasic, sodium phosphate tribasic, potassium phosphate dibasic, potassium phosphate tribasic, and a combination thereof.

13. The composition for a beverage according to claim 9, wherein size of the basic particles is 100 μm to 5,000 μm.

14. The composition for a beverage according to claim 9, wherein the water-soluble polymer is selected from the group consisting of hydroxypropyl methyl cellulose, methyl cellulose, hydroxypropyl cellulose, guar gum, gum arabic, locust bean gum, gellan gum, xanthan gum, carrageenan, gum tragacanth, gum karaya, gum ghatti, dhamma gum, psyllium seed gum, tamarind gum, tara gum, polyvinylpyrrolidone, modified starch, and a combination thereof.

15. The composition for a beverage according to claim 9, wherein the third substance further comprises an acidic substance.

16. The composition for a beverage according to claim 15, wherein the acidic substance is selected from the group consisting of citric acid, malic acid, tartaric acid, gluconic acid, lactic acid, vitamin C, gluconolactone, L-aspartame, L-glutamic acid, acidic sodium pyrophosphate, potassium hydrogen tartrate, sodium phosphate monobasic, potassium phosphate monobasic, citrus-containing extract powder, and a combination thereof.

17. The composition for a beverage according to claim 1, wherein the composition is in a powder form.

18. The composition for a beverage according to claim 9, wherein the composition is in a powder form.
